(19) United States
(12) Patent Application Publication
(10) Pub. No.: US 2006/0027453 A1
(43) Pub. Date: Feb. 9, 2006

(54) Low resistance reference junction

(76) Inventors: Lauren M. Catalano, Wrentham, MA (US); Michael M. Bower, Wareham, MA (US)

Correspondence Address: Richard L. Sampson;SAMPSON & ASSOCIARES, P.C., 50 Congress Street, Boston, MA, 02109, US

(21) Appl. No.: 11/198,085

(22) Filed: Aug. 5, 2005

Related U.S. Application Data
(60) Provisional application No. 60/598,943, filed on Aug. 5, 2004.

(51) Int. Cl. G01N 27/26

(52) U.S. Cl. 204/435

(57) ABSTRACT

A reference half-cell and method includes a reference electrode and a reference electrolyte disposed in mutual electrolytic contact, and a reference junction including a porous member configured to provide controlled flow of the reference electrolyte therein to form a primary electrical pathway extending through the member. A secondary electrical pathway is disposed electrically in parallel with the primary electrical pathway.

### BACKGROUND OF THE INVENTION

(1) Field of the Invention

The present invention generally relates to electrochemical sensors and more particularly to reference half-cells for use in pH, oxidation/reduction potential, and selective ion activity measurements.

(2) Background Information

Throughout this application, various publications, patents and published patent applications are referred to by an identifying citation. The disclosures of the publications, patents and published patent applications referenced in this application are hereby incorporated by reference into the present disclosure.

Electrochemical potential measurements are commonly used to determine solution pH, other selective ion activities, ratios of oxidation and reduction activities, as well as other solution characteristics. A pH/ion selective electrode/oxidation reduction potential meter (hereafter referred to as a pH/ISE/ORP meter) is typically a modified voltmeter that measures the electrochemical potential between a reference half-cell (of known potential) and a measuring half-cell. These half-cells, in combination, form a cell, the electromotive force (emf) of which is equal to the algebraic sum of the potentials of the two half-cells. The meter is used to measure the total voltage across the two half-cells. The potential of the measuring half-cell is then determined by subtracting the known potential of the reference half-cell from the total voltage value.

The measuring half-cell typically includes an ion selective material such as glass. The potential across the ion selective material is well known by those of ordinary skill in the art to vary in a manner that may generally be described by the Nernst Equation, which expresses the electrochemical potential as a logarithmic function of ion activity (thermodynamically corrected concentration). A pH meter is one example of a pH/ISE/ORP meter wherein the activity of hydrogen ions is measured. pH is defined as the negative logarithm of the hydrogen ion activity and is typically proportional to the measured electrochemical potential.

FIG. 1 is a schematic of a typical, prior art arrangement 20 for measuring electrochemical potential. Arrangement 20 typically includes a measuring half-cell 30 and a reference half-cell 40 immersed in a process solution 24 and connected to an electrometer 50 by connectors 38 and 48, respectively. Measuring half-cell 30 and reference half-cell 40 are often referred to commercially (as well as in the vernacular) as measuring electrodes and reference electrodes, respectively. Electrometer 50 functions similarly to a standard voltage meter in that it measures a D.C. voltage (electrochemical potential) between measuring half-cell 30 and reference half-cell 40. Measuring half-cell 30 typically includes a half-cell electrode 36 immersed in a half-cell electrolyte 32, which is typically a standard solution (e.g., in pH measurements). For some applications, such as pH measurement, measuring half-cell 30 also includes an ion selective material 34. Alternately, when measuring ORP the half-cell electrode 36 is immersed directly into the process solution 24.

The purpose of the reference half-cell 40 is generally to provide a stable, constant (known) potential against which the measuring half-cell may be compared. Reference half-cell 40 typically includes a half-cell electrode 46 immersed in a half-cell electrolyte 42 (FIG. 1). As used herein, the term “half-cell electrode” refers to the solid-phase, electron-conducting material in contact with the half-cell electrolyte, at which contact the oxidation-reduction reaction occurs that establishes an electrochemical potential. Half-cell electrolyte 42 (FIG. 1) is hereafter referred to as a reference electrolyte. Electrochemical contact between the reference electrolyte 42 (FIG. 1) and the process solution is typically established through a reference junction 44, which often includes a porous ceramic plug or the like (e.g., porous Teflon® (polytetrafluoroethylene, DuPont), porous KYNAR® (polyvinyldifluoride, Elf Atochem, N.A.), or wood) for achieving restricted fluid contact. Ideally, the reference junction 44 is sufficiently porous to allow a low resistance contact (which is important for accurate potential measurement) but not so porous that the solutions become mutually contaminated.

However, for many applications, particularly those having a relatively high ion concentration and/or those at a relatively high temperature, ion contamination is a significant difficulty. Both contamination of the reference electrolyte with process solution components and contamination of the process solution with reference electrolyte components are relatively common. Further, clogging of the reference junction with a variety of contaminants (e.g., process solution salts or silver chloride from the reference electrolyte) is also a relatively common difficulty with typical commercial reference electrodes. Both ion contamination and reference junction clogging may lead to unstable and/or erroneous measurements and therefore tend to be undesirable and problematic.

Turning now to the known art, there have been several attempts to overcome the above stated difficulties. For example, U.S. Pat. No. 4,495,052 to Brezinski and U.S. Pat. No. 4,495,053 to Souza (hereafter referred to as the '052 and '053 patents, respectively) disclose reference electrodes having a removable and replaceable reference junction, the reference junction typically consisting of a ceramic plug within a glass tube. The '052 and '053 patents, while possibly providing for improved convenience, do not provide an ion-barrier and therefore do not tend to reduce ion contamination. The reference junctions disclosed therein may also be fragile and prone to breakage during removal and insertion.

Nipkow, et al., in U.S. Pat. No. 5,470,453 (hereafter referred to as the '453 patent) disclose a double junction type silver/silver chloride reference electrode that features a silver ion reducing agent acting as a silver ion-barrier layer to reduce contamination of the junction electrolyte and reference junction with silver ions and/or silver chloride precipitate. This reference junction is not configured to eliminate migration of process solution components (e.g., ions or other mobile species) into the reference electrolyte. Contamination of the reference electrolyte may therefore be problematic in some applications.

To address this problem, the ceramic rod or plug of many conventional reference junctions is generally provided with a relatively small diameter and pore size to minimize electrolyte flow out of the sensor and into the process solution. However, an unintended effect of this approach has been a tendency for resistance across the reference junction to rise to undesirably high levels in some applications.

U.S. Pat. No. 6,495,012 (the '012 patent) entitled Sensor for Electrometric Measurement, assigned to The Foxboro Company, discloses an electrode assembly which uses a spring loaded piston to pressurize an electrolyte reservoir and generate electrolyte flow. This flow is taught to prevent backflow of contaminants from the process solution into the electrolyte. While this approach may be effective for many applications, it tends to be relatively complex and costly to manufacture. The '012 patent is fully incorporated herein by reference.

Therefore, there exists a need for an improved reference electrode and/or reference electrode junction for use in pH, selective ion activity, oxidation-reduction potential (ORP), and other electrochemical potential measurements that addresses the aforementioned difficulties.

### SUMMARY

In accordance with one aspect of the invention, a reference half-cell includes a reference electrode and a reference electrolyte disposed in electrolytic contact therewith. A reference junction is also provided, which includes a porous member configured to provide controlled flow of the reference electrolyte therein to form a primary electrical pathway extending through the member. A secondary electrical pathway is disposed electrically in parallel with the primary electrical pathway.

In variations of the foregoing, the secondary electrical pathway is independent of any fluid flow through the porous member. Such flow-independence may be provided by provision of a solid state material in the form of an electrically conductive polymeric sleeve disposed concentrically with a porous member in the form of a ceramic plug. Alternatively, a solid state material such as hydrophilic electrolyte-laden gel may be mechanically captured within the pores of the porous member. As a further alternative, the solid state material may comprise a metallic material, carbon based material, and/or dehydrated electrolyte particulate mixed with a ceramic material which is then formed into the porous member to chemically and/or mechanically bond the material of the secondary electrical pathway to the porous member.

Another aspect of the present invention includes a method for measuring electrochemical potential. This method includes the steps of providing the aforementioned reference half-cell, providing a measuring half-cell, inserting the reference half-cell and the measuring half-cell into a liquid, and electrically connecting the reference half-cell and the measuring half-cell to a meter. The meter is then used to generate a total voltage value, from which is subtracted the potential of the reference half-cell.

A further aspect of the invention includes a method of fabricating a reference half-cell, which includes providing a reference electrode, disposing a reference electrolyte in electrolytic contact with the reference electrode, and providing a reference junction which includes a porous member configured to provide controlled flow of the reference electrolyte therein to form a primary electrical pathway extending through the member. A secondary electrical pathway is disposed electrically in parallel with the primary electrical pathway.

### BRIEF DESCRIPTION OF THE DRAWINGS

FIG. 1 is a schematic representation of a typical electrochemical potential measurement system of the prior art;

FIG. 2 is a schematic representation of sensor assembly embodying aspects of the present invention;

FIGS. 3-6 are schematic, not-to-scale representations of alternate embodiments of a portion of the assembly of FIG. 2; and

FIG. 7 is a graphical representation of test results of a prior art (control) device; and

FIGS. 8-10 are graphical representations of test results of embodiments of the present invention.

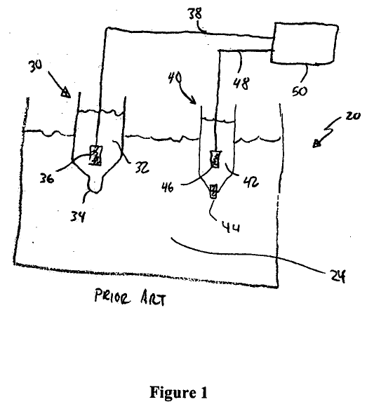

### DETAILED DESCRIPTION

Commercially available DolpHin PH10™ (Foxboro Company) pH sensors utilize a porous ceramic rod (e.g., plug) to form a reference junction. A KYNAR® sleeve is melted over the porous ceramic rod to facilitate assembly by press fitting it into a bore within the sensor body. As with the art discussed above, the purpose of this junction is to provide a low resistance, liquid ionic contact between the internal reference electrolyte and the external process solution.

The ceramic rod is provided with a relatively small diameter and pore size to minimize electrolyte flow out of the sensor (and into the process solution). However, in some situations, resistance of the reference junction has been found to undesirably increase (e.g., to 100K-Ohms or more) within a relatively short period of time, often within minutes. Resistance of this magnitude has been found to be often associated with fouling of the reference junction, e.g., with the porous rod becoming coated or otherwise clogged. This level of resistance thus generally triggers alarms in the relatively sophisticated electronic diagnostic systems associated with many process variable transmitters, such as those of the type sold by Invensys Systems, Inc. (Foxboro, Mass.). Moreover, resistances of this magnitude also tend to be beyond the practical limits of older, legacy equipment, which typically do not have high impedance inputs for reference electrodes.

An aspect of the present invention was the recognition by the present inventors that the rapid increase in resistance often occurred when the reference junction was used in applications involving relatively low ionic strength process solutions under pressure higher than that of the internal reference electrolyte. While not wishing to be tied to any particular theory, it is suspected that the rapid increase in resistance occurs when the low ionic strength process fluid moves, e.g., due to the pressure gradient, into the pores of the porous rod, diluting and/or replacing the reference electrolyte therein. Since the process fluid is of low ionic strength, it is also of relatively high electrical resistance. Moreover, the equivalent cross-sectional area of the ceramic rod is relatively small, e.g., as small as 0.050 inches in diameter. This small cross-sectional area, in combination with the high resistivity of the process fluid disposed within the pores of the porous rod, is thus believed to be at least partially responsible for the relatively high measured resistance of the reference junction.

This suspected cause of high resistance has been confirmed by tests in which a flow constrictor, such as a paper wick, was inserted into the reference electrode. The constrictor was found to slow the rate of resistance increase ostensibly by slowing the movement of process fluid into the porous rod. However, though the rate of increase was demonstrably slowed, the resistance was still found to reach the unacceptable 100 K-Ohm level in an unacceptably short period of time (e.g., in approximately one hour). It was suspected that this latter increase was due to a different mechanism, i.e., due to a reduction in diffusion of the KCL reference electrolyte from the reservoir into the process solution via the porous rod. It is therefore believed that the paper wick, by effectively slowing the movement of liquid into and out of the porous rod, also inhibited diffusion to an extent by which it became a significant factor affecting KCL concentration, and thus resistance, of the junction. In this regard, those skilled in the art will recognize that a reduction in diffusion rate generally corresponds to an increase in resistance. Thus, while the constrictor advantageously helped to slow the increase in resistance by slowing movement of process fluid into the plug, it also appeared to disadvantageously slow the rate of diffusion of KCl into the plug, which had the opposite effect of increasing the resistance thereof.

Embodiments of the present invention advantageously maintain the total resistance of the reference junction assembly at an acceptable level, while maintaining the relatively small cross-sectional area of the porous junction (referred to variously herein as a rod or plug) to help prevent excessive mass flow therethrough. These embodiments address the aforementioned drawbacks by using a secondary, flow-independent (e.g., solid state) electrical pathway, with or without a flow constrictor (e.g., wick), to maintain conductivity at levels sufficient for electrode operation. Examples of these flow-independent pathways include one or more of: a conductive holder for the porous plug; a porous plug impregnated with electrolyte-laden gel; and a porous electrically conductive plug.

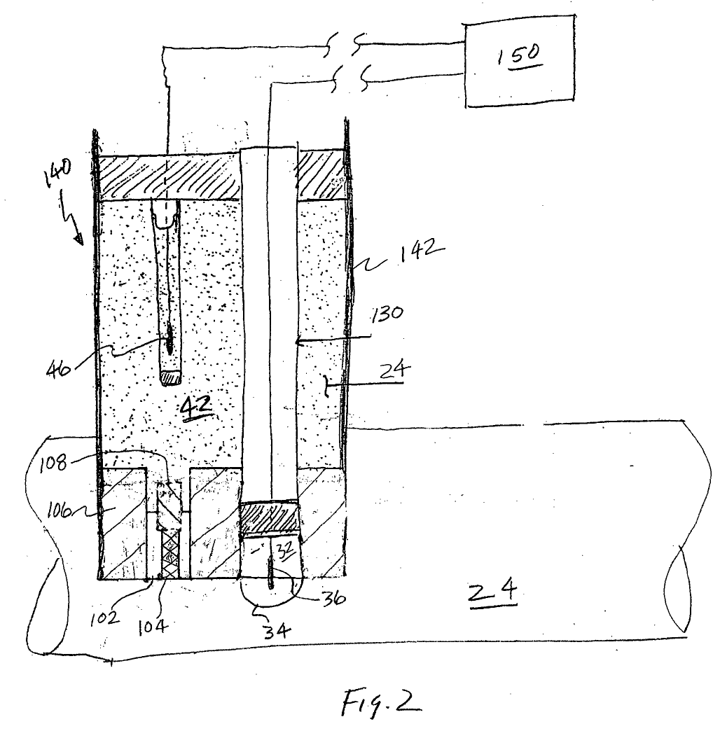

Referring to FIG. 2, one embodiment of the invention includes a low resistance reference junction 100 incorporated within a sensor 120. In this embodiment, sensor 120 includes a commercially available DolpHing PH10™ (Foxboro Company) pH sensor, which has been modified in accordance with the teachings of the present invention.

As shown, sensor 120 includes a measuring half-cell 130 and a reference half-cell 140 disposed in a common housing 142. At least a portion (e.g., a lower portion) of sensor 120 is configured for immersion in a process solution 24 (e.g., a process solution passing through a conduit as shown), and connected to an electronic diagnostic system 150. Diagnostic system 150 may comprise a conventional process variable transmitter (PVT) coupled to a factory automation network of the type sold by Invensys Systems, Inc., which is configured to measure the electrochemical potential between half-cells 130 and 140.

As shown, measuring half-cell 130 is of the type having an electrode 36 immersed in a conventional half-cell electrolyte 32 disposed within an ion selective material 34, e.g., to effect pH measurement. Alternately, however, electrode 36 may be immersed directly into process solution 24, such as to measure ORP as discussed hereinabove. Those skilled in the art will recognize that substantially any type of measuring electrode may be used in various embodiments of the present invention.

Reference half-cell 140 includes a conventional half-cell electrode 46, typically encased in a cation exchange membrane, such as a NAFION® (sulphonated polytetrafluoroethylene membrane) available from DuPont. Electrode 46 is immersed in reference electrolyte 42 disposed within an electrolyte reservoir 110.

Electrochemical contact between the reference electrolyte 42 and process solution 24 is established through reference junction 104, which includes a porous ceramic plug or the like (e.g., porous Teflon®, porous KYNAR®, wood, or nominally any other porous material) for achieving restricted fluid contact. Reference junction 104 is sufficiently porous to allow a low resistance contact (for accurate potential measurement) but not so porous that the solutions become excessively mutually contaminated. The skilled artisan will recognize that pore size, percent porosity, and effective cross-sectional area of the reference junction 104 must all be balanced, in conjunction with the particular electrolyte used, to achieve the desired restricted fluid contact. In the particular embodiment shown, junction 104 includes a porous ceramic plug of the type conventionally used in the aforementioned DolpHin™ sensor, e.g., having an effective diameter of approximately 0.05 to 0.14 inches, pore sizes between about 1 to 2 μm, and total percent porosity of 20 to 30 volume percent.

In the embodiment shown, a conductive sleeve 102 fabricated from a conductive polymeric material such as KYNAR® or the like, is melted or otherwise placed concentrically about the porous ceramic rod 104. Sleeve 102 is thus used in lieu of the conventional non-conductive KYNAR® sleeve commonly used to facilitate assembly. This rod/sleeve assembly is then press-fit into an appropriately sized and shaped bore within sensor body 106. Optionally, a flow constrictor 108 (shown in phantom), e.g., in the form of a wick of paper, cotton, or other porous material, may also be placed between the rod 104 and the reference electrolyte 42. Conductive sleeve 102 provides a separate electrical path between the reference electrolyte (e.g., IMole KCl) 42, and the process fluid 24, to thus minimize the total resistance of the reference junction.

The optional flow constrictor 108 may be used to reduce the flow of process fluid 24 through rod 104 and into reservoir 110, to further minimize any increase in resistance of the reference junction, such as may be due to displacement of reference electrolyte from rod 104 or other contamination by process fluid 24. Flow constrictor 108 similarly tends to decrease the loss of reference electrolyte 42 into process fluid 24, to help increase the useful life of the electrode.

Any electrochemical effects acting on the conductive sleeve 102 tend to be minimal, but may vary depending on the particular conductive material from which the sleeve is fabricated. In particular embodiments, sleeve 102 is fabricated from the same conductive KYNAR® material commonly used in the solution ground (not shown) of the DolpHin™ sensors, so that any such effects will be nominally identical to those acting on the solution ground. Since measurement (e.g., pH) is a function of the difference of measurement taken between the solution ground and reference half-cell 140, and between the solution ground and measuring half-cell 130, any such electrochemical effects tend to advantageously cancel one another.

Although KYNAR® is described as a representative material for sleeve 102, nominally any conductive material may be used in various applications, without departing from the spirit and scope of the invention. Conductive KYNAR® was used in this exemplary embodiment primarily for convenience, since it may be conveniently melted onto plug 104 and installed into body 106 in the manner currently used with the non-conductive KYNAR® sleeves of the DolpHin™ sensors. However, those skilled in the art will recognize that any number of other materials may be similarly melt processed.

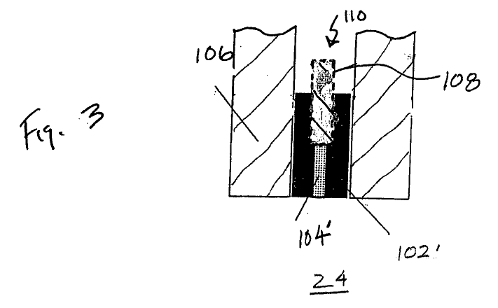

Referring now to FIG. 3, in an alternate embodiment of the present invention, a conventional non-conductive sleeve (e.g., non-conductive KYNAR®) 102′, is disposed concentrically with a conductive junction (e.g., plug) 104′. This plug 104′ may be fabricated from substantially any porous material having conductive properties, such as electrically conductive alumina based ceramics commercially available from DuPont®, or various ceramics having carbon fiber or other conductive materials, such as salts, disposed therein. The conductive material of plug 104′ advantageously serves as a secondary flow-independent (e.g., solid state) conductive pathway which helps maintain the total resistance of the reference junction assembly at an acceptable level, while maintaining the relatively small cross-sectional area of the porous junction to help restrict excessive mass flow therethrough. In the event further restriction of mass flow is desired, this embodiment may also be used with optional flow constrictor 108, as shown in phantom.

Exemplary material from which conductive plug 104′ may be fabricated includes a mixture of conventional (e.g., non-conductive) ceramic and dehydrated electrolyte. In this regard, water may be evaporated from a KCl solution, and the remaining KCl crystal salts mixed with ceramic (e.g., alumina) powder. The ceramic/KCl mixture may then be formed into the desired shape using conventional ceramic fabrication techniques (e.g., extrusion, or other application of heat and pressure such as molding and furnacing). In this manner, a uniform distribution of embedded KCl sites is provided throughout the porous ceramic plug. These sites provide a conductive pathway through the ceramic to the saturated KCl reference electrolyte 42 in reservoir 110. Since the sites are effectively embedded and captured within the ceramic, many, if not substantially all, of the sites tend to be flow-independent, i.e., resistant to displacement by process fluid flowing through the porous ceramic.

Any of various known electrolytes may be mixed with any of various ceramic materials to form plug 104′. However, use of the same electrolyte (e.g., KCl) as that used as reference electrolyte 42 (e.g., KCl) tends to advantageously generate, little, if any, unwanted electrical noise, since the electrolyte embedded in the plug will exhibit nominally the same electrolytic activity as the electrolyte 42 disposed within reservoir 110.

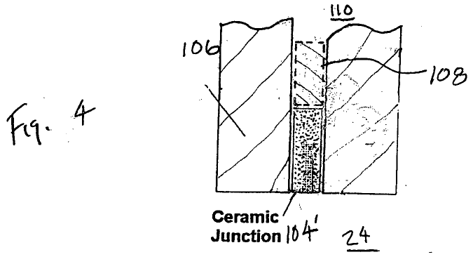

A variation of the embodiments of FIG. 3, involves the use of conductive ceramic plug 104′ without holder 102′, as shown in FIG. 4. Flow constrictor 108 may be optionally used, as shown in phantom.

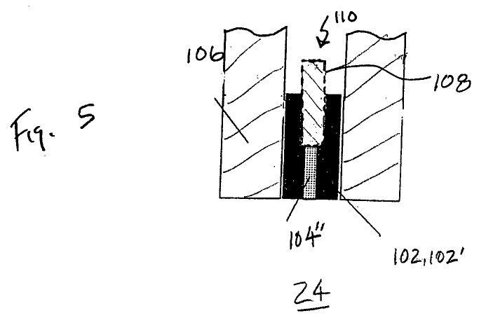

Yet another embodiment, shown in FIG. 5, is substantially similar to that shown and described with respect to FIG. 2, but uses a higher concentration (e.g., 4M) reference electrolyte in reservoir 110. Prior to use, this relatively highly concentrated electrolyte flows or diffuses from reservoir 110 into the porous plug to create a plug/electrolyte combination (shown as 104″) which exhibits relatively high conductivity. This plug 104″, including this concentrated electrolyte, tends to further enhance the conductivity provided by conductive holder 102. Moreover, in some applications, plug 104″ may provide sufficient conductivity even when used without conductive holder 102. As with previous embodiments, optional flow constrictor 108 may be used if desired.

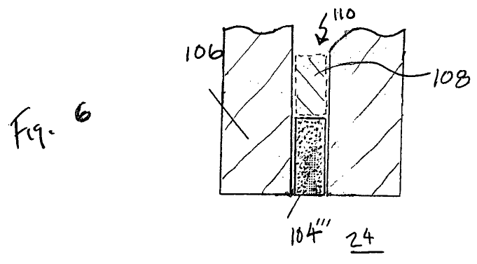

A still further embodiment of the present invention, shown in FIG. 6, uses a porous plug 104′″ which has been impregnated with electrolyte-laden gel to provide it with a secondary electrical pathway therein. The gel may, for example, comprise a hydrophilic material such as cellulose, which expands when in contact with water to form a substantially solid state material that remains captured within the pores of the plug during operation. In this manner, the electrolyte-laden gel provides a secondary electrical pathway that is flow-independent, i.e., that by virtue of its capture within the pores, resists displacement due to fluid flow through the plug.

In particular embodiments, plug 104′″ may be fabricated by providing ceramic plugs of conventional diameters (e.g., about 0.05 to 0.14 inches), but having relatively large pores, e.g., 5-10 μm or more to facilitate receipt of the gel therein. A cellulose based powder is mixed with a KCl solution (e.g., 4 Mole). The plugs are then placed in a dish with the cellulose/KCl solution, and placed under a vacuum to force the Cellulose/KCl solution through the pores of the plugs where it solidifies. This electrolyte-laden gel thus forms a substantially solid state electrolytic path between the reference half cell and the process solution, through which diffusion may advantageously take place, but which may limit or nominally eliminate ingress of the process fluid. Again, this embodiment may be used with or without optional flow constrictor 108, shown in phantom.

The following illustrative examples are intended to demonstrate certain aspects of the present invention. It is to be understood that these examples should not be construed as limiting.

### EXAMPLES

### Example 1

### Control

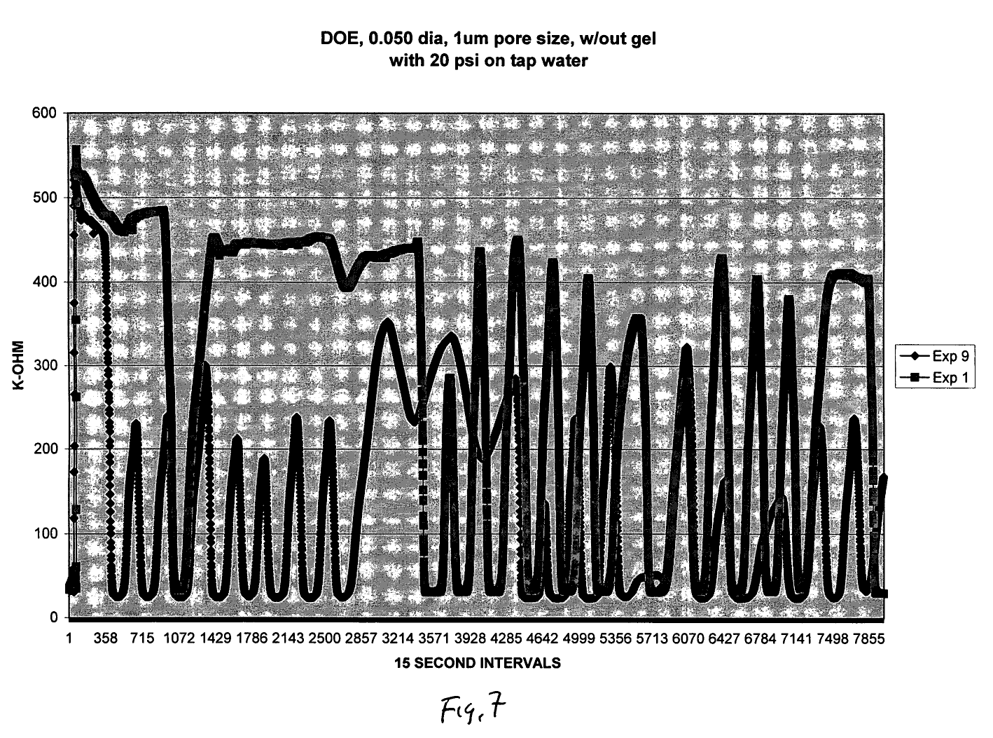

Conventional reference junctions, having a conventional porous ceramic plug 104 fabricated from 244B ceramic (244B porous 70% alumina ceramic from Homexx International) of 0.050 inch diameter, approximately 1 μm pore size, 26 percent pore volume, and using a KCL reference electrolyte, were tested using a process solution of tap water at 20 psi. Resistance measurements were captured at 15 second intervals over approximately 130 minutes. As shown in FIG. 7, the resistance measured by these conventional devices routinely exceeded 100 k-Ohm and often reached or exceeded 300-400 k-Ohm.

### Example 2

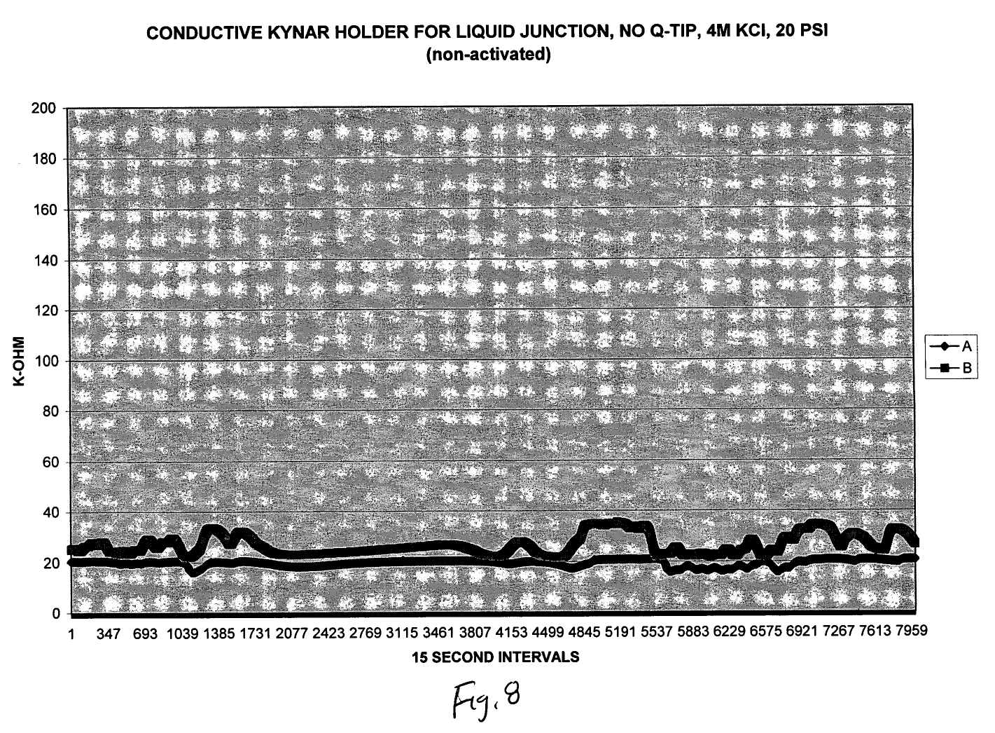

Reference junctions in accordance with the subject invention were fabricated substantially as described in Example 1, but also having a conductive (KYNAR®) sleeve 102 as described above with respect to FIG. 5 (without a flow constrictor 108). These devices were tested under conditions substantially similar to those of Example 1, for approximately 32 hours. As shown in FIG. 8, the resistance measured by these inventive devices remained well below 100 k-Ohm, and seldom exceeded 35 k-Ohm.

### Example 3

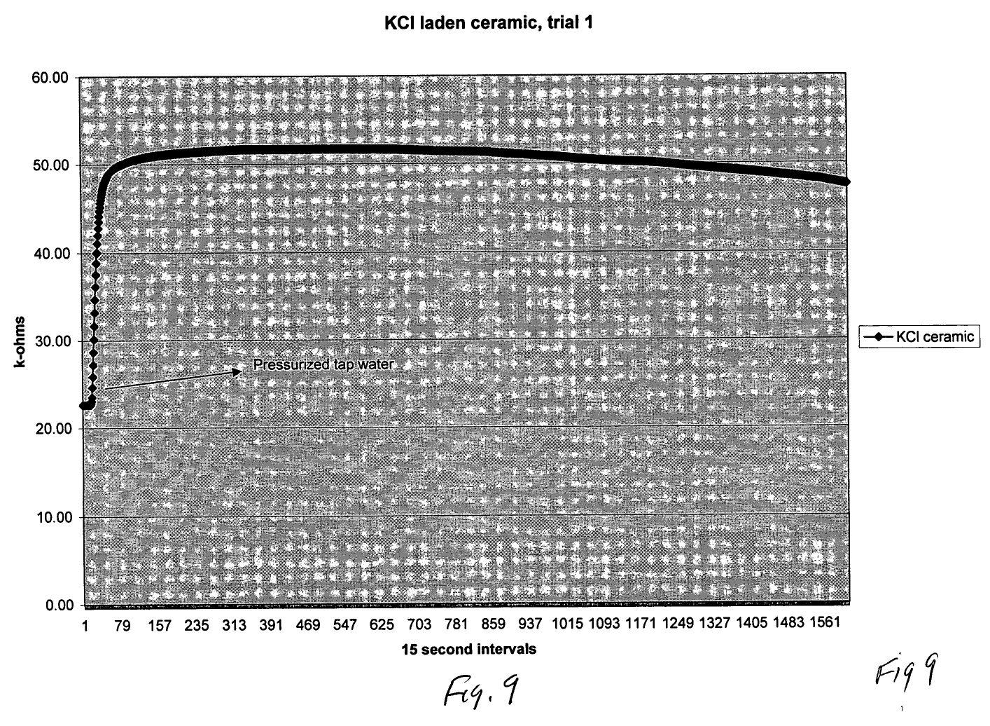

A reference junction in accordance with the subject invention was fabricated substantially as described in Example 1, but using a porous ceramic plug 104′ formed by mixing ceramic alumina powder with dehydrated KCl, which was then formed into plugs by conventional extrusion as described hereinabove with respect to FIG. 3. This device was tested under conditions substantially identical to those of Example 1, for approximately six hours. As shown in FIG. 9, the resistance measured by this inventive device remained well below 100 k-Ohm, rising to a maximum of about 51.7 k-Ohm before decreasing.

### Example 4

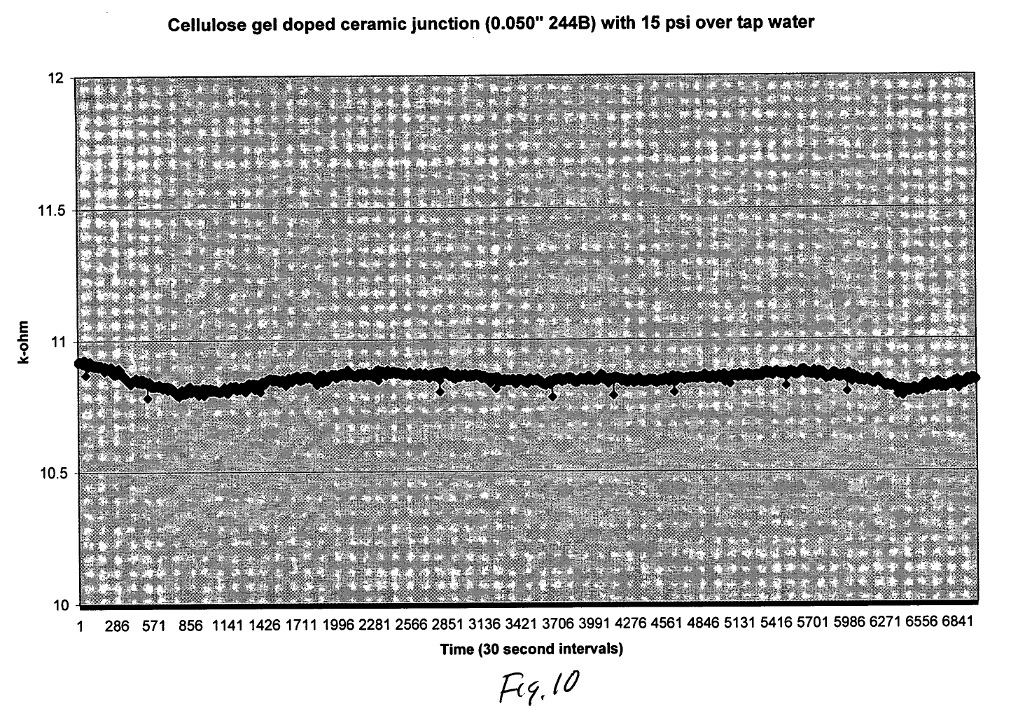

A reference junction in accordance with the subject invention was fabricated substantially as described in Example 1, but using a porous ceramic plug 104′″ having pores of about 10 μm, which were impregnated with KCl-laden cellulose gel as described hereinabove with respect to FIG. 6. This device was tested under conditions substantially identical to those of Example 1, using a process solution of tap water at 15 psi for over 50 hours. As shown in FIG. 10, the resistance measured by this inventive device remained below 11 k-Ohm for the duration of the test.

While several embodiments of the present invention have been shown and described with various characteristics, it should be understood that one or more of these characteristics of one embodiment may be substituted or added to characteristics of other embodiments without departing from the spirit and scope of the present invention.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A reference half-cell comprising:
a reference electrode;
a reference electrolyte disposed in electrolytic contact with the reference electrode;
a reference junction including a porous member configured to provide controlled flow of the reference electrolyte therein to form a primary electrical pathway extending through the member;
a secondary electrical pathway disposed electrically in parallel with said primary electrical pathway.

2. The reference half-cell of claim 1, wherein said secondary electrical pathway is independent of any fluid flow through said porous member.

3. The reference half-cell of claim 1, wherein said secondary electrical pathway comprises a solid state material.

4. The reference half-cell of claim 1 wherein said porous member comprises a porous ceramic plug.

5. The reference half-cell of claim 4, wherein said solid state material comprises a sleeve of electrically conductive polymer disposed concentrically with said plug.

6. The reference half-cell of claim 4, wherein said member and said solid state material are received within a suitably sized and shaped passage within a body, said porous member being configured for contact with the reference electrolyte disposed inside the body, and with a process fluid disposed outside the body.

7. The reference half-cell of claim 1, wherein said secondary electrical pathway comprises an electrically conductive solid state material disposed within said porous member.

8. The reference half-cell of claim 7, wherein said porous member is fabricated from a porous, electrically conductive material.

9. The reference half-cell of claim 8, wherein said porous member is fabricated from a porous, electrically conductive ceramic.

10. The reference half-cell of claim 9, wherein said porous, electrically conductive ceramic comprises an electrically conductive particulate dispersed throughout a non-conductive ceramic material.

11. The reference half-cell of claim 7, wherein said secondary electrical pathway comprises an electrically conductive material captured at sites dispersed through said porous member.

12. The reference half-cell of claim 11, wherein said electrically conductive material comprises electrically conductive particulate chemically bonded throughout said porous member.

13. The reference half-cell of claim 12, wherein said electrically conductive particulate comprises carbon fiber.

14. The reference half-cell of claim 12, wherein said electrically conductive particulate comprises dehydrated electrolyte.

15. The reference half-cell of claim 11, wherein said electrically conductive material comprises electrically conductive particulate mechanically bonded throughout said porous member.

16. The reference half-cell of claim 15, wherein said electrically conductive particulate comprises electrolyte-laden gel captured within the pores of said porous member.

17. The reference half-cell of claim 16, wherein the electrolyte-laden gel comprises an hydrophilic gel mixed with an electrolyte selected from the group consisting of potassium chloride, silver chloride, mixtures of silver chloride and potassium chloride, potassium sulfate, methyl cyanide, and combinations thereof.

18. The reference half-cell of claim 1 wherein said body comprises plastic.

19. The reference half-cell of claim 1 wherein said electrolyte comprises a potassium chloride solution.

20. The reference half-cell of claim 19 further comprising a four molar potassium chloride solution disposed within the pores of said porous member.

21. The reference half-cell of claim 1 further comprising a flow constrictor disposed in fluid communication with said porous member.

22. The reference half-cell of claim 21 wherein said flow constrictor is disposed within a body containing said reference electrolyte.

23. The reference half-cell of claim 21 wherein said flow constrictor comprises paper.

24. The reference half-cell of claim 1 wherein said reference electrode comprises a member of the group consisting of silver, silver-silver chloride, mercury-mercurous sulfate, mercury-mercurous chloride, and other redox couples.

25. The reference half-cell of claim 1 wherein said reference electrode comprises silver-silver chloride.

26. The reference half-cell of claim 1 wherein said reference electrolyte comprises a member of the group consisting of potassium chloride, silver chloride, mixtures of silver chloride and potassium chloride, potassium sulfate, methyl cyanide, and combinations thereof.

27. The reference half-cell of claim 1 wherein said reference electrolyte comprises a mixture of silver chloride and potassium chloride.

28. The reference half-cell of claim 27 wherein said reference electrolyte comprises a mixture of about 4 molar potassium chloride and saturated silver chloride.

29. An electrochemical potential measurement sensor comprising:
a measuring half-cell; and
the reference half-cell of claim 1.

30. The sensor of claim 29 wherein said measuring half-cell and said reference half-cell are disposed in a common housing and coupled to a process variable transmitter.

31. The sensor of claim 29 wherein said measuring half-cell comprises a pH electrode.

32. The sensor of claim 29 wherein said measuring half-cell comprises a selective ion electrode.

33. The sensor of claim 29 wherein said measuring half-cell comprises a fluoride ion selective electrode.

34. The sensor of claim 29 wherein said measuring half-cell comprises an oxidation-reduction potential electrode.

35. The sensor of claim 29 wherein said measuring half-cell is sized and shaped for removable insertion into a sensor housing.

36. A method for measuring electrochemical potential comprising:
(a) providing the reference half-cell of claim 1;
(b) providing a measuring half-cell;
(c) inserting said reference half-cell and said measuring half-cell into a liquid;
(d) electrically connecting said reference half-cell and said measuring half-cell to a meter;
(e) using the meter to generate a total voltage value; and
(f) subtracting the potential of the reference half-cell from the total voltage value.

37. A method of fabricating a reference half-cell comprising:
(a) providing a reference electrode;
(b) disposing a reference electrolyte in electrolytic contact with the reference electrode;
(c) providing a reference junction including a porous member configured to provide controlled flow of the reference electrolyte therein to form a primary electrical pathway extending through the member; and
(d) disposing a secondary electrical pathway electrically in parallel with said primary electrical pathway.

38. The method of claim 37, wherein said disposing (d) comprises configuring said secondary electrical pathway to be independent of any fluid flow through the porous member.

39. The method of claim 37, wherein said disposing (d) comprises configuring said secondary electrical pathway from a solid state material.

40. The method of claim 39, wherein said disposing (d) comprises forming said secondary electrical pathway from an electrically conductive layer superposed with said porous member.

41. The method of claim 39, wherein said disposing (d) comprises forming said secondary electrical pathway by disposing an electrically conductive solid state material within said porous member.

42. The method of claim 41, wherein said disposing (d) comprises:
(e) mixing a conductive particulate with ceramic particulate to form a mixture;
(f) forming the mixture into a porous member.

43. The method of claim 42, wherein the conductive particulate comprises dehydrated electrolyte.

44. A reference half-cell comprising:
a body;
a half-cell electrode disposed within the body;
a reference electrolyte disposed within the body;
a reference junction including a porous non-electrically conductive ceramic plug;
a conductive sleeve disposed in concentric superposed engagement with the plug;
the sleeve and plug being received within a suitably sized and shaped bore within the body, wherein the plug is configured for contact with the reference electrolyte, and with a process fluid disposed outside the body.

45. A reference half-cell comprising:
a body;
a half-cell electrode disposed within the body;
a reference electrolyte disposed within the body;
a reference junction including a porous electrically conductive ceramic plug;
the plug being received within a suitably sized and shaped bore within the body, wherein the plug is configured for contact with the reference electrolyte and with a process fluid disposed outside the body.

46. A reference half-cell comprising:
a body;
a half-cell electrode disposed within the body;
a reference electrolyte disposed within the body;
a reference junction including a porous non-electrically conductive ceramic plug;
an electrolyte-laden hydrophilic gel impregnated within the pores of the plug;
the plug being received within a suitably sized and shaped bore within the body, wherein the plug is configured for contact with the reference electrolyte, and with a process fluid disposed outside the body.
